(19) United States
(12) Patent Application Publication
(10) Pub. No.: US 2012/0292466 A1
(43) Pub. Date: Nov. 22, 2012

(54) ADHESIVE SUPPORTER

(76) Inventor: Soon Young Song, Gyeonggido (KR)

(21) Appl. No.: 13/196,706

(22) Filed: Aug. 2, 2011

(30) Foreign Application Priority Data
May 20, 2011 (KR) 10-2011-0047707

(51) Int. Cl. F16B 47/00; B60R 7/00

(52) U.S. Cl. 248/205.4; 248/205.8; 224/400

(57) ABSTRACT

Provided is an adhesive supporter configured to temporarily support a car navigation, a cellular phone, or the like, and in particular, to an adhesive supporter capable of more reliably and stably suctioning and holding a car navigation, a cellular phone, or the like by increasing a vacuum force between an attachment surface thereof and a pad of the adhesive supporter.

### CROSS-REFERENCE TO RELATED APPLICATIONS

This application claims priority under 35 U.S.C. §119 to Korean Patent Application No. 10-2011-0047707, filed on May 20, 2011, in the Korean Intellectual Property Office, the present invention of which is incorporated herein by reference in its entirety.

### TECHNICAL FIELD

The following disclosure relates to an adhesive supporter configured to temporarily support a car navigation, a cellular phone, or the like, and in particular, to an adhesive supporter capable of more reliably and stably suctioning and holding a car navigation, a cellular phone, or the like by increasing a vacuum force between an attachment surface thereof and a pad of the adhesive supporter.

### BACKGROUND

In recent years, a supporter has been widely used by being fixed to a front window, a dashboard, or the like in the interior of a car to support a cellular phone, a navigation, a monitor, or the like (hereinafter, generally referred to as a ‘mobile device’) thereon.

There is disclosed a technique for suctioning and supporting the mobile device using magnetic attraction. However, in such a technique, the mobile device is attached using a permanent magnet. Therefore, this magnetic supporter may not be practically used on the ground that the mobile device is often turned off when an electronic device such as the mobile device is near the magnet.

In addition to the magnetic supporter, there is known a technical structure in which a bracket grips the mobile device using a spring force exerted laterally. However, even this structure has a problem in that various buttons disposed at the left and right surfaces of the mobile device are often pushed by mistake.

In addition, a structure may be conceived in which an auxiliary member is attached to the back surface of the mobile device and the mobile device is attached to the supporter. However, there are problems in that the mobile device may be unclean or may not be commonly used and the auxiliary member may be attached to each of all mobile devices or other products.

Furthermore, a structure shown in FIGS. 1a and 1b is considered in which the mobile device is attached or detached using an adhesive plate known as a flat adhesive plate. FIG. 1a illustrates a state before the mobile device is attached to the supporter, and FIG. 1b illustrates a state where the mobile device is attached to the supporter. In the supporter with such a structure, a central member (not shown) integrally formed with the center of an adhesive plate 13 connects the adhesive plate 13 and a lever 11 to each other. When the lever disposed perpendicularly is pushed to be horizontal, the center of the adhesive plat 13 connected to the lever 11 is pulled toward the inside of a housing 12, so that the adhesive plate 13 is formed in an upward recess shape as depicted by the dashed line of FIG. 1b. Accordingly, the internal space between the adhesive plate 13 and the attachment surface expands, so that the air pressure between the adhesive plate 13 and the attachment surface becomes lower than the atmospheric pressure and hence the mobile device is suctioned and supported by the supporter.

However, this flat adhesive plate supporter may not be conveniently used since the mobile device is made contact the supporter by one hand and the lever is pressed by the other hand. Further, since the suction force is exerted due to a difference between the internal pressure and the atmosphere pressure caused by the deformation with the upward recess shape as shown in FIG. 1b, there is a concern that the pad is deformed when the pad is used for a long time. When the pad is deformed once, an internal space is already present between the adhesive plate 13 and the attachment surface before the lever is operated. For this reason, even when the internal space is expanded through the operation of the lever, sufficient adhesiveness may not be provided. Moreover, when the ambient temperature increases due to hot weather or the like, the pressure of the air of the internal space increases to become equivalent to the atmospheric pressure. As a result, the supporter loses the adhesiveness thereof and hence the mobile device is often dropped from the attachment surface.

### SUMMARY

An embodiment of the present invention is directed to providing an adhesive supporter capable of supporting a cellular phone or the like using a vacuum force between a pad of the adhesive supporter and an attachment surface of a mobile device such as a car navigation or a cellular phone to be supported thereon, and more reliably and stably suctioning and holding the mobile device such as the cellular phone by maintaining a pressure between the pad of the adhesive supporter and the attachment surface in a vacuum state without operating an additional mechanism such as a lever.

Another embodiment of the present invention is directed to providing an adhesive supporter with a structure capable of suctioning and supporting a mobile device without plastic deformation of a pad of the adhesive supporter.

Another embodiment of the present invention is directed to providing an adhesive supporter capable of effectively suctioning and supporting a mobile device even when the attachment surface thereof is rough or not planar.

In one general aspect, there is an adhesive supporter for attaching a mobile device including a cellular phone, a PDA, and a navigation thereto, including: a pad suctioned to an attachment surface of the mobile device; a central member uprightly fixed to the top surface of the pad; a housing having a hole allowing the central member to pass therethrough and disposed on the top surface of the pad; a planar stopper member bonded to the central member; a cylindrical ball receiving portion formed on the back surface of the stopper member such that a knurling is formed on the outside thereof and the ball receiving portion is segmented by notched grooves; and an elastic member providing an elastic force between the outer peripheral surface of the housing and the stopper member, wherein the central member moves the center of the pad upward using the elastic force of the elastic member to maintain the pad in a recess shape, and the attachment surface is pushed against the back surface of the pad to be attached thereto, so that a space between the attachment surface and the back surface of the pad becomes a vacuum state and the mobile device is suctioned and held by the adhesive supporter.

In another general aspect, the ball receiving portion may rotatably receive a round ball formed at one end of a fixed body fixed to a car or the like.

In another general aspect, industrial gel with adhesiveness may be heat-fixed to the back surface of the pad. Furthermore, the top surface of the pad may be etched.

In another general aspect, the adhesive supporter may further include an attaching and detaching mechanism formed in one surface of the pad to pull one side of the pad.

In another general aspect, the adhesive supporter may further include a cover member integrally extending from the stopper member to cover the housing, and the housing and the cover member may be provided with a groove or a hole allowing the attaching and detaching mechanism to pass therethrough.

In another general aspect, the elastic member may be a coil spring surrounding the central member between the housing and the stopper member.

In another general aspect, a portion of the housing corresponding to the center of the pad may be formed in a recess shape, a portion corresponding to the outer periphery of the pad may be formed in a flat shape to contact the outer periphery, and the portion contacting the outer periphery of the pad may be provided with a circular protrusion.

The above and other objects and benefits will become more apparent by the following description for describing the exemplary embodiments with reference to the accompanying drawings.

### BRIEF DESCRIPTION OF THE DRAWINGS

The above and other objects, features and advantages of the present invention will become apparent from the following description of certain exemplary embodiments given in conjunction with the accompanying drawings, in which:

FIGS. 1a and 1b are diagrams illustrating a shape before and after a conventional adhesive plate supporter is operated,

FIG. 2 is a diagram illustrating an appearance of an adhesive supporter according to one embodiment of the present invention,

FIG. 3 is an entire exploded perspective view illustrating the adhesive supporter according to the present invention,

FIGS. 4a and 4b are diagrams illustrating the operation of the adhesive supporter according to the present invention,

FIGS. 5a and 5b are diagrams illustrating an angle adjusting function of the adhesive supporter according to the present invention, and

FIG. 6 is a cross-sectional view illustrating the adhesive supporter according to another embodiment of the present invention.

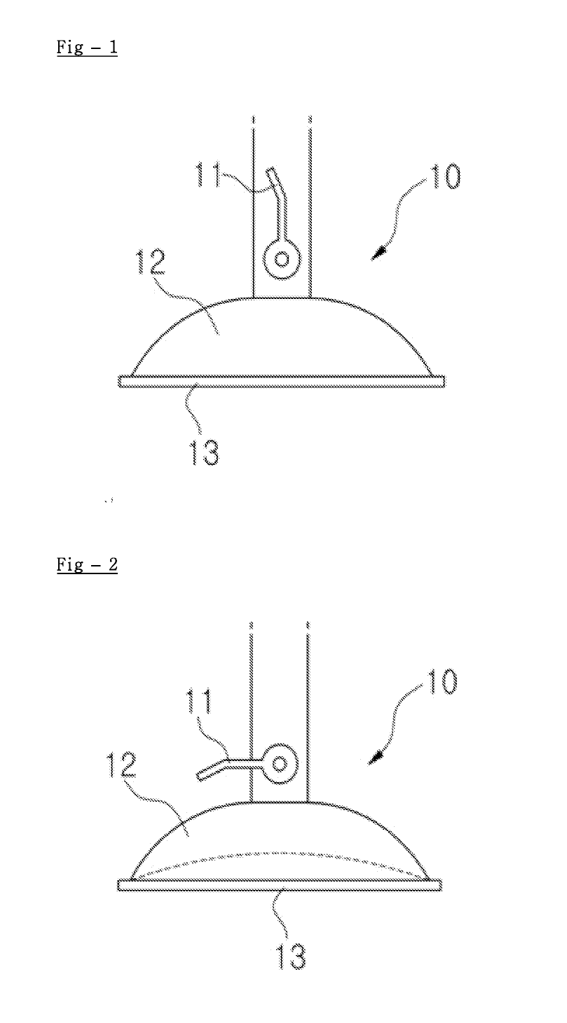

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this present invention will be thorough and complete, and will fully convey the scope of the present invention to those skilled in the art. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. Hereinafter, exemplary embodiments will be described in detail with reference to the accompanying drawings.

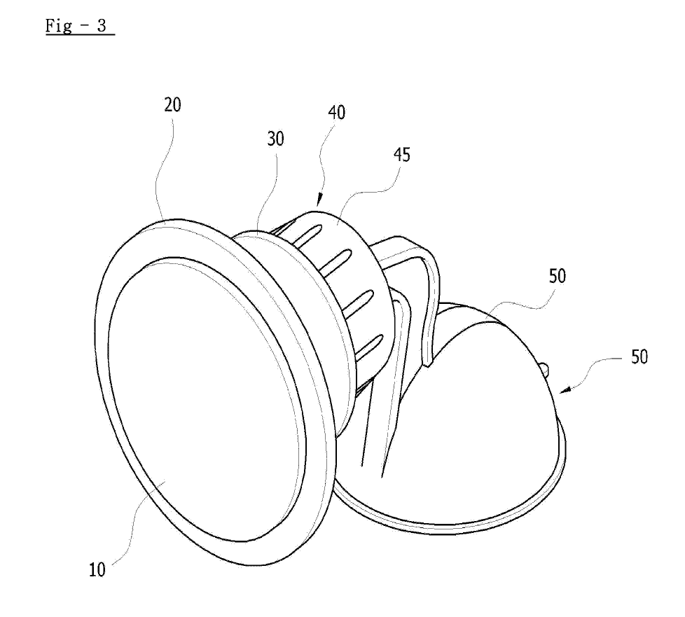

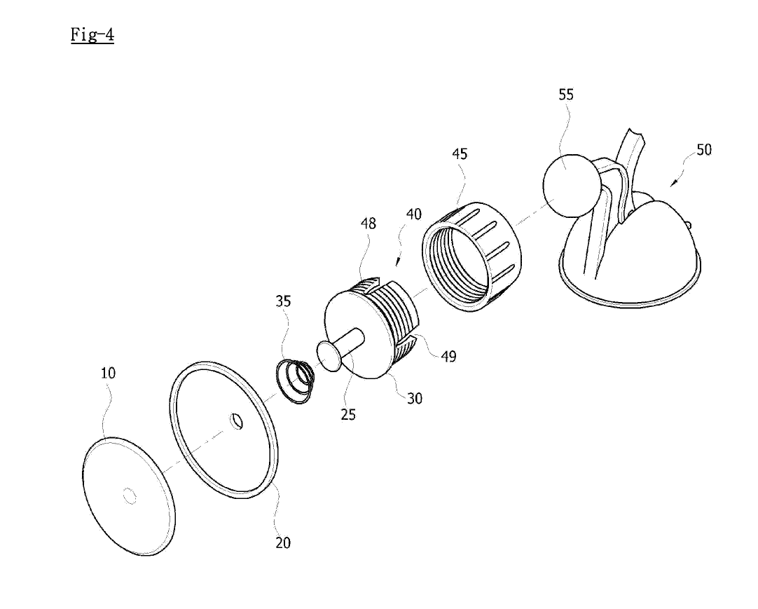

FIG. 2 is a diagram illustrating an appearance of an adhesive supporter according to one embodiment of the present invention, and FIG. 3 is an entire exploded perspective view illustrating the adhesive supporter according to the present invention.

Referring to FIG. 3, the adhesive supporter according to the present invention includes a pad 10, a central member 25, a housing 20, a stopper member 30, a ball receiving portion 40, and a fixed body 50 of which one end is provided with a round ball and which is fixed to a car or the like.

The pad 10 includes a back surface suctioned to an attachment surface of a mobile device and a top surface connected to the central member 25. The top surface of the pad 10 may be etched to prevent the portion contacting the housing 20 from sticking to the housing 20 when they are used for a long time. When such etching is performed, the pad may be prevented from sticking to the housing 20 when they are used for a long time, and the mobile device may be easily attached or detached.

The central member 25 is uprightly fixed to the center of the top surface of the pad 10, and maintains the shape of the pad 10 in a recess shape by moving the center of the pad 10 upward due to an action of an elastic member 35 between the housing 20 and the stopper member 30.

The housing 20 has a round semi-spherical shape, and has a hole provided at the center thereof so that the central member 25 passes therethrough. In the embodiment, the housing 20 is depicted in a semispherical shape, but may have a shape in which the portion corresponding to the center of the pad 10 is formed in a recess shape to form a space where the center of the pad 10 has a recess shape, and the portion corresponding to the outer periphery of the pad 10 is formed in a flat shape to contact the pad 10. When the housing 20 is formed to contact the pad 10 along the outer periphery of the pad 10, a plurality of circular protrusions may be formed in the portion of the housing contacting the pad to more efficiently maintain a vacuum state by concentrating a pressure.

The central member 25 is bonded to the stopper member 30 through the hole formed in the housing 20. The elastic member 35 is interposed between the stopper member 30 and the housing 20. In the embodiment, the elastic member 35 is exemplified as a coil spring, but it is apparent by the person skilled in the art that the present invention is not limited thereto.

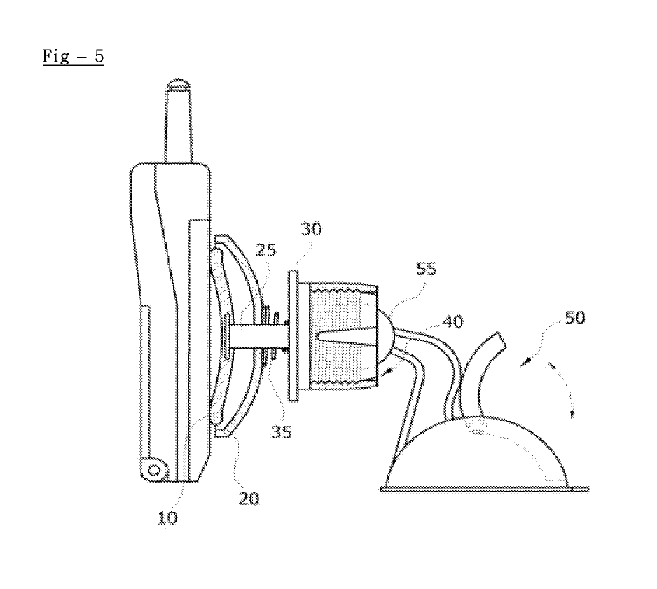

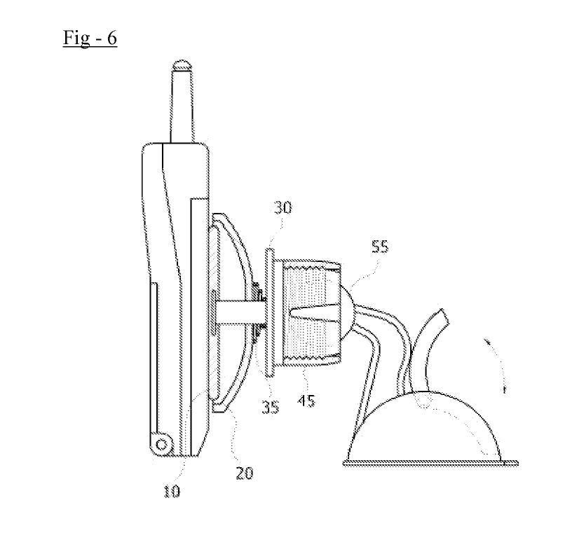

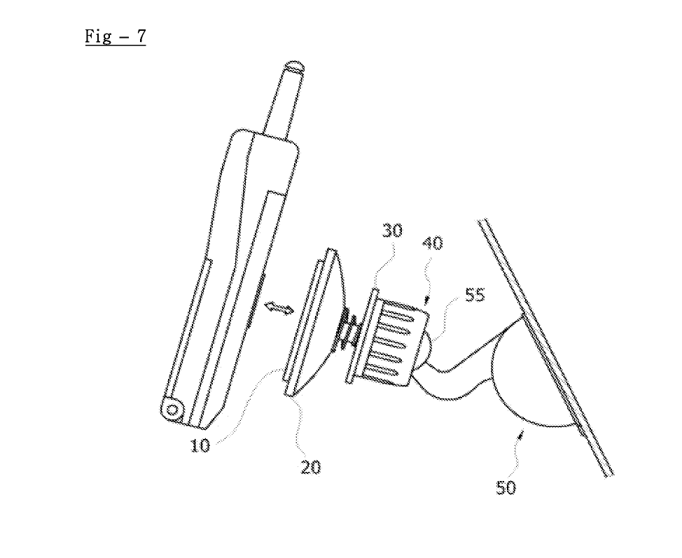

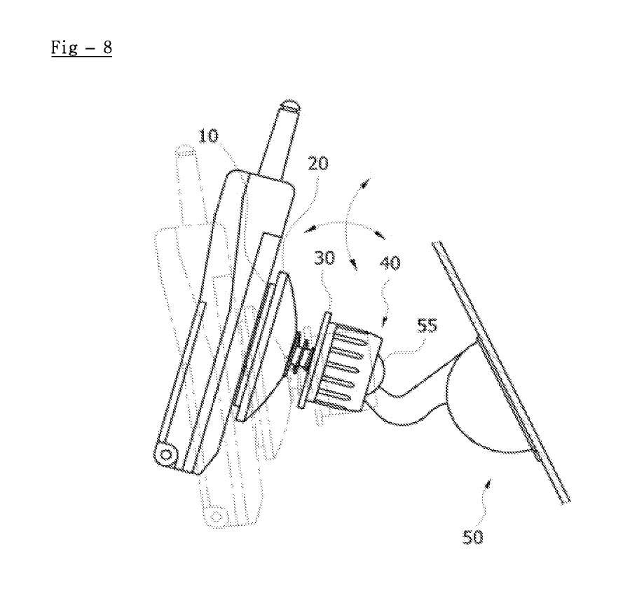

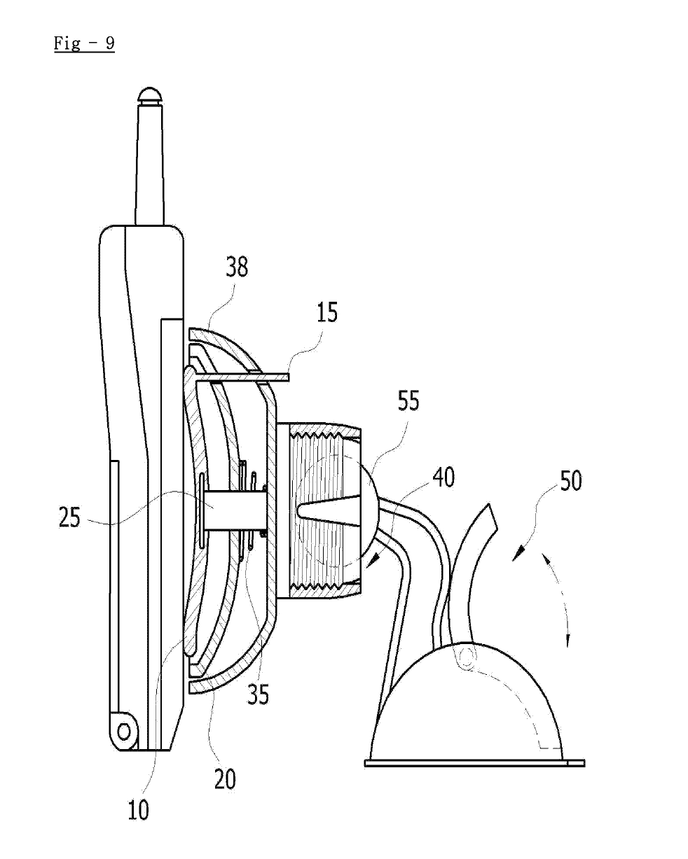

A cylindrical ball receiving portion 40 protrudes from the back surface of the stopper member 30 such that a knurling 48 is formed on the outside of the ball receiving portion and the ball receiving portion is segmented by notched grooves 49. One end of the fixed body 50 fixed to a car or the like is provided with a round ball 55 that is received in the ball receiving portion 40. The round ball 55 is received in the ball receiving portion 40, and the outer diameter portion of the ball receiving portion 40 is fastened and fixed by a fastening ring 45, so that the adhesive supporter according to the present invention is strongly fixed to the car. Since the round ball 55 is rotatably received inside the ball receiving portion 40, the angle of the adhesive supporter according to the present invention may be optionally adjusted by a user as shown in FIGS. 5a and 5b.

The fixed body 50 may be used by being permanently attached to one surface of the car using a double-sided adhesive tape, a screw, or the like, or may be used by being optionally attached thereto using an adhesive plate generally known as a flat adhesive plate. Since the method of fixing the fixed body to the car or the like is out of the scope of the present invention, the detailed description thereof will be omitted.

The operation of making the mobile device suctioned and supported by the adhesive supporter according to the present invention will be specifically described by referring to FIGS. 4a and 4b.

In the adhesive supporter according to the present invention, as shown in FIG. 4a, the pad 10 is maintained in a recess shape in a manner such that the central member 25 bonded to the stopper member 30 using the elastic force of the elastic member 35 between the housing 20 and the stopper member 30 pulls the center of the pad 10 connected to the central member 25.

As shown in FIG. 4b, when the mobile device is adhered to the pad 10 to suction and support the mobile device, the internal air between the pad 10 and the attachment surface of the mobile device leaks, so that the pad 10 is suctioned to the attachment surface in a perfect vacuum state. Likewise, since the adhesive supporter according to the present invention may suction and hold the mobile device just by pushing the mobile device against the pad of the adhesive supporter without operating any mechanism such as a lever, the adhesive supporter may be simply used. Furthermore, since the pad 10 is suctioned to the attachment surface of the mobile device in a flat shape without plastic deformation as shown in FIG. 4b, there is an effect that the suction force may be maintained even after long-term use.

Furthermore, soft industrial gel with adhesiveness may be heat-fixed to the back surface of the pad 10. The industrial gel is elastomer that is formed by putting a hardening agent such as polyol and a plasticizer such as ether and ester into isocyanate or the like. The hardness of the industrial gel becomes different from that of the pad 10 depending on the content of plasticizer, and the adhesiveness changes depending on the hardness. The close contact state between the attachment surface and the pad 10 may be more strongly maintained by the adhesiveness. Furthermore, even when the attachment surface of the mobile device is rough, since the cavities formed on the rough surface is closely and reliably filled with the soft gel, the pad may be effectively adhered to the attachment surface in a close contact state.

FIG. 6 is a cross-sectional view illustrating the adhesive supporter according to another embodiment of the present invention.

The adhesive supporter according to the embodiment is substantially the same as the embodiment of FIG. 3 except that an attaching and detaching mechanism 15 is formed on the top surface of the outer periphery of the pad to easily attach or detach the mobile device to or from the adhesive supporter and a cover member 38 integrally extends from the stopper member 30 to cover the housing 20.

When the attaching and detaching mechanism 15 is pulled, air enters between the pad 10 and the attachment surface of the mobile device, so that the vacuum state is canceled. In this state, the mobile device may be easily attached or detached. The housing 20 and the cover member 38 are provided with a groove or a hole through which the attaching and detaching mechanism passes.

Since the cover member 38 is formed to cover the housing 20, the central member 25, and the elastic member 35, the adhesive supporter according to the present invention has a neat appearance.

The adhesive supporter according to the present invention may support the cellular phone or the like using a vacuum force between the pad of the adhesive supporter and the attachment surface of the mobile device such as the car navigation or the cellular phone to be supported thereon. Further, the adhesive supporter may more reliably and stably suction and hold the mobile device such as the cellular phone by maintaining a pressure between the pad of the adhesive supporter and the attachment surface in a vacuum state without operating an additional mechanism such as a lever.

Furthermore, according to the present invention, since the pad of the adhesive supporter is used to suction and support the mobile device in the state where the pad does not have plastic deformation, the suction force may be maintained even after long-term use. And, since the industrial gel with adhesiveness is heat-fixed to the back surface of the pad, even the mobile device having a rough attachment surface may be effectively suctioned and supported by the adhesive supporter.

While the present invention has been described with respect to the specific embodiments, it will be apparent to those skilled in the art that various changes and modifications may be made without departing from the spirit and scope of the present invention as defined in the following claims.

What is claimed is:

1. An adhesive supporter for attaching a mobile device including a cellular phone, a PDA, and a navigation thereto, comprising:
a pad suctioned to an attachment surface of the mobile device;
a central member uprightly fixed to the top surface of the pad;
a housing having a hole allowing the central member to pass therethrough and disposed on the top surface of the pad;
a planar stopper member bonded to the central member;
a cylindrical ball receiving portion formed on the back surface of the stopper member such that a knurling is formed on the outside thereof and the ball receiving portion is segmented by notched grooves; and
an elastic member providing an elastic force between the outer peripheral surface of the housing and the stopper member,
wherein the central member moves the center of the pad upward using the elastic force of the elastic member to maintain the pad in a recess shape, and the attachment surface is pushed against the back surface of the pad to be attached thereto, so that a space between the attachment surface and the back surface of the pad becomes a vacuum state and the mobile device is suctioned and held by the adhesive supporter.

2. The adhesive supporter according to claim 1, wherein the ball receiving portion rotatably receives a round ball formed at one end of a fixed body fixed to a car or the like.

3. The adhesive supporter according to claim 1, wherein industrial gel with adhesiveness is heat-fixed to the back surface of the pad.

4. The adhesive supporter according to claim 1, wherein the adhesive supporter comprises an attaching and detaching mechanism formed in one surface of the pad to pull one side of the pad.

5. The adhesive supporter according to claim 3, wherein the adhesive supporter further comprises a cover member integrally extending from the stopper member to cover the housing, and the housing and the cover member are provided with a groove or a hole allowing the attaching and detaching mechanism to pass therethrough.

6. The adhesive supporter according to claim 1, wherein the elastic member is a coil spring surrounding the central member between the housing and the stopper member.

7. The adhesive supporter according to claim 1, wherein the top surface of the pad is etched.

8. The adhesive supporter according to claim 1, wherein a portion of the housing corresponding to the center of the pad is formed in a recess shape, a portion corresponding to the outer periphery of the pad is formed in a flat shape to contact the outer periphery of the pad, and the portion contacting the outer periphery of the pad is provided with a circular protrusion.

9. The adhesive supporter according to claim 2, wherein the adhesive supporter comprises an attaching and detaching mechanism formed in one surface of the pad to pull one side of the pad.

10. The adhesive supporter according to claim 3, wherein the adhesive supporter comprises an attaching and detaching mechanism formed in one surface of the pad to pull one side of the pad.

11. The adhesive supporter according to claim 2, wherein the elastic member is a coil spring surrounding the central member between the housing and the stopper member.

12. The adhesive supporter according to claim 3, wherein the elastic member is a coil spring surrounding the central member between the housing and the stopper member.

13. The adhesive supporter according to claim 2, wherein the top surface of the pad is etched.

14. The adhesive supporter according to claim 3, wherein the top surface of the pad is etched.

15. The adhesive supporter according to claim 2, wherein a portion of the housing corresponding to the center of the pad is formed in a recess shape, a portion corresponding to the outer periphery of the pad is formed in a flat shape to contact the outer periphery of the pad, and the portion contacting the outer periphery of the pad is provided with a circular protrusion.

16. The adhesive supporter according to claim 3, wherein a portion of the housing corresponding to the center of the pad is formed in a recess shape, a portion corresponding to the outer periphery of the pad is formed in a flat shape to contact the outer periphery of the pad, and the portion contacting the outer periphery of the pad is provided with a circular protrusion.
